(19) United States
(12) Patent Application Publication
(10) Pub. No.: US 2010/0245891 A1
(43) Pub. Date: Sep. 30, 2010

(54) Systems and Methods for Fast Printing

(75) Inventor: Kiyoshi Miyake, Superior, CO (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 12/416,111

(22) Filed: Mar. 31, 2009

(51) Int. Cl. G06F 3/12

(52) U.S. Cl. 358/1.15

(57) ABSTRACT

Methods disclosed permit the accelerated printing of documents. In some embodiments, a method for accelerating the printing of documents utilizes a first pre-processed file, which is obtained by pre-processing a second file. The pre-processed file is associated with stored attribute information for the second file. When a print request is received for the second file, updated file attribute information for the second file is retrieved and used to determine if there are content changes to the second file. In some embodiments, content changes may be detected by comparing the retrieved updated file attribute information with the stored file attribute information. The pre-processed file is used for printing, if there are no content changes to the second file.

### BACKGROUND

1. Field of the Invention

The present invention relates to the field of printing and in particular, to systems and methods to speed-up the printing of documents by printers through the use of remote monitoring and pre-processing techniques.

2. Description of Related Art

Computer printers, which are ubiquitous in most modern organizations, permit the quick printing of stored documents. Designers of modern printers have focused relentlessly on improving printer speed, efficiency, color accuracy, and cost resulting in virtually universal adoption of printers. Nevertheless, in order to optimize resource usage, most organizations use a network of printers to serve people in the organization. Because these printers may be accessed seamlessly over computer networks, the printing of documents is facilitated. In addition, networking allows the system to be fault tolerant and permits users to switch to other printers when a printer malfunctions or demands service.

However, despite the advances in printing technology users often experience delays when printing documents on network printers. These delays occur, in part, because printers first receive or retrieve documents over a network, which is followed by the processing and rasterization of these documents prior to physical printing. For large documents, printers may spend a significant amount of time to obtain, process, and rasterize the document. Consequently, users may experience delays before they can retrieve a physical printed document from a printer.

In addition to contributing to lost productivity and decreasing printer utilization, such delays also increase the risk that sensitive documents may be left unattended on printer trays because users may wait prior to retrieving printed documents immediately after printing. Therefore, there is a need for systems and methods for to speed up document printing in order to decrease the delays experienced by users when printing documents to a printer.

### SUMMARY

Consistent with embodiments disclosed herein, systems and methods for printing at least one first file associated with stored attribute information pertaining to a second file are presented In some embodiments, the first file is obtained by pre-processing the second file, and the method comprises the steps of: receiving a print request for the second file; retrieving current file attribute information pertaining to the second file; determining if there are content changes to the second file by comparing the retrieved file attribute information with the stored file attribute information; and printing the first file, if there are no content changes to the second file.

Embodiments also relate to software, firmware, and program instructions created, stored, accessed, or modified by processors using computer-readable media or computer-readable memory. The methods described may be performed on a computer and/or a printing device.

These and other embodiments are further explained below with respect to the following figures.

### BRIEF DESCRIPTION OF THE DRAWINGS

FIG. 1 shows a block diagram of an exemplary system for printing documents consistent with disclosed embodiments.

FIG. 1A shows a high level block diagram of an exemplary printer.

FIG. 2 shows exemplary system for accelerated printing using monitoring folders consistent with disclosed embodiments.

FIG. 3 shows a flowchart illustrating an exemplary method for configuring printers to enable file monitoring.

FIG. 4 shows a flowchart depicting an exemplary method for the fast printing of files according to disclosed embodiments.

FIG. 5 shows an exemplary flowchart for a file monitoring method consistent with disclosed embodiments.

### DETAILED DESCRIPTION

In accordance with embodiments disclosed herein, systems and methods to accelerate the printing of documents by printers are presented.

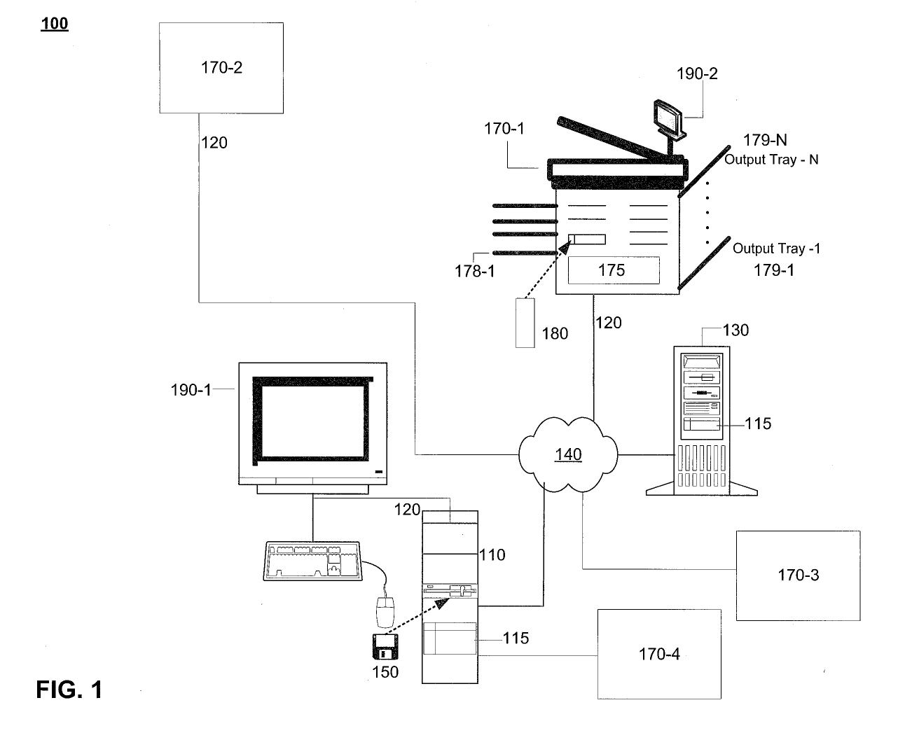

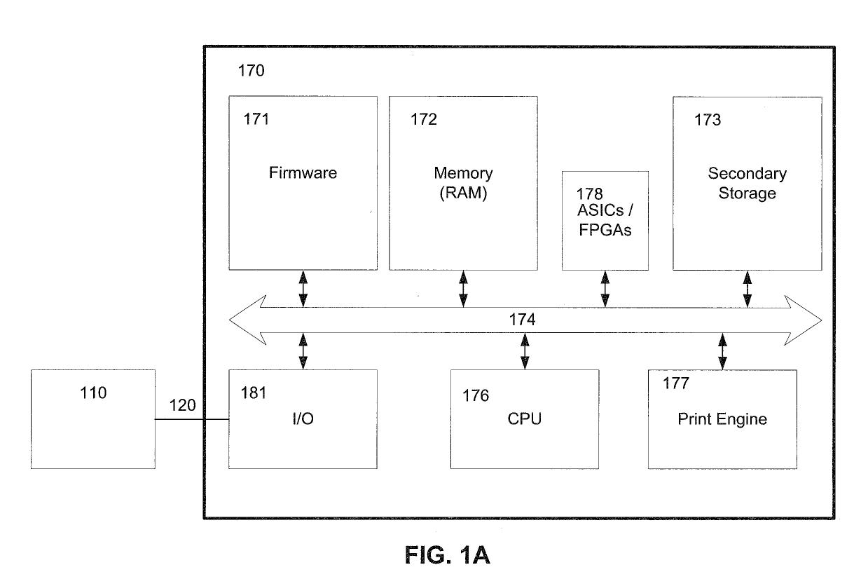

FIG. 1 shows a block diagram of exemplary system 100 for printing documents consistent with disclosed embodiments. A computer software application to speed-up document printing may be deployed on a network of computers and/or printers, as shown in FIG. 1, that are connected through communication links that allow information to be exchanged using conventional communication protocols and/or data port interfaces.

As shown in FIG. 1, exemplary system 100 includes a computer or computing device 110 and a server 130. Further, computing device 110 and server 130 may communicate over a connection 120, which may pass through one or more networks 140, which in one case could be the Internet. Networks 140 may include subnets, LANs, and/or WANs. Further, network 140 may also include modems, routers, repeaters, and other communication devices (not shown) that permit devices that are coupled to a network 140 to communicate with other devices. For example, as shown in FIG. 1, printers 170-2, 170-3, and 170-4 may communicate with each other and with other devices coupled to network 140.

Computing device 110 may be a computer workstation, desktop computer, laptop computer, or any other computing device capable of being used in a networked environment. Server 130 may be a platform capable of connecting to computing device 110 and other devices too (not shown). Computing device 110 and server 130 may be capable of executing software (not shown) using processors that allow the configuration of printers 170 to accelerate the printing of documents.

Printers 170 may be laser printers, ink jet printers, LED printers, plotters, and various other types. From a functional perspective, printers 170 may take the form of computer printers, facsimile machines, digital copiers, multi-function devices, and/or various other devices that are capable of printing documents. Computing device 110 and server 130 may contain secondary storage 115, which may include removable media accessed using removable media drive 150. Secondary storage 115 may include one or more hard disks, fixed flash memory, and/or other non-volatile memory. Removable media drive 150 may include, for example, 3.5 inch floppy drives, CD-ROM drives, DVD ROM drives, CD±RW or DVD±RW drives, USB™ flash drives, Memory Sticks™, Secure Digital High Capacity (“SDHC”) cards, and/or any other removable media drives consistent with embodiments of the present invention. Portions of software applications to accelerate printing may reside on removable media and be read and executed by computing device 110 using removable media drive 150. In some embodiments, intermediate and final results and/or reports generated by applications may also be stored on removable media.

Connection 120 couples computing device 110, server 130, and printers 170-1-170-6 to networks 140. Connection 120 may be implemented as a wired or wireless connection using conventional communication protocols and/or data port interfaces. In general, connection 120 can be any communication channel that allows transmission of data between the devices. In one embodiment, for example, the devices may be provided with conventional data ports, such as USB™, SCSI, FIREWIRE™, and/or BNC ports for transmission of data through the appropriate connection 120. The communication links could be wireless links or wired links or any combination that allows communication between computing device 110, server 130, and printers 170.

Networks 140 could include a LAN, a WAN, or the Internet. Printers 170, such as exemplary printer 170-2, may be network printers that can be coupled to network 140 through connection 120. System 100 may include multiple printers 170 and other peripherals (not shown).

Printers 170 may be controlled by processors and other hardware, firmware, or software. Printers 170 may include one or more print controller boards 175, which may control the operation of printers 170, and may also perform portions of configuration and accelerated print functions. Printers 170 may be controlled by firmware or software resident on memory devices in print controller 175. In general, print controller 175 may be internal or external to printers 170. In some embodiments, printers 170 may also be controlled in part by software, including print servers, printer drivers, or other software, running on computing device 110 or server 120.

Printers, such as exemplary printer 170-1, may also include console 190 such as consoles 190-1 and 190-2, or other interfaces to allow various configuration options to be set, print jobs to be selected for printing, passwords and/or user identification and authentication information to be entered, and other messages to be displayed. In some embodiments, the configuration options may include associating one or more network accessible files with a monitoring folder accessible by printer 170. In some embodiments, the monitoring folder may reside on printer 170 and may comprise pre-processed versions of the associated network accessible files.

In some embodiments, configuration options may be set or displayed using a display or user-interface on a monitor for a computer coupled to printers 170. For example, user interfaces to set one or more configuration options on printer 170-1 may be displayed on console 190-1. In some embodiments, a user interface to set configuration options on printers 170-2-170-4 may also be displayed on console 190-1, and appropriate configuration messages may be sent to printers 170-2-170-4. For example, the selecting or deleting of files associated with a file monitoring folder, the print resolution, document sizes, color options, and other configuration parameters may be user-configurable.

Users may also be able to log in to a printer 170 to perform administrative functions such as to enable software or firmware on printer 170 to perform various functions. In some embodiments, the log-in process may require a password or other user-authentication mechanism. A user may also be able to specify input trays 178 and/or output trays 179 and the use of automatic document feeders to allow batch processing of documents. Printers 170 may have multiple input trays 178 and/or output trays 179. Output trays 179 can hold printed documents that have been processed by a printer.

A computer software application to accelerate document printing on printers 170 may be deployed on any of the exemplary computers 110, server 130, and/or printers 170, as shown in FIG. 1. For example, computing device 110 could execute software, such as a user interface coupled to a print driver, to allow users to configure, control, and/or monitor the operation of printer 170-1. An independent application may also execute concurrently on printer 170-2 based on its configuration. In another example, an application resident on print controller 175 could be configured using computer 110 but execute on printer 170-1. In general, applications may execute in whole or in part on one or more computers, print controllers, or printers in the system. The embodiments described above are exemplary only and other embodiments and implementations will be apparent to one of reasonable skill in the art.

FIG. 1A shows a high-level block diagram of exemplary printer 170 coupled to a computing device 110 over connection 120. Exemplary printer 170 may contain bus 174 that couples CPU 176, firmware 171, memory 172, input-output ports 181, print engine 177, and secondary storage device 173. Exemplary printer 170 may also contain other Application Specific Integrated Circuits (ASICs), and/or Field Programmable Gate Arrays (FPGAs) 178 that are capable of executing portions of an application to configure printer 170 and to accelerate the printing of documents. Exemplary printer 170 may also be able to access network storage devices over network 140, as well as secondary storage or other memory in computing device 110 using I/O ports 181 and connection 120. In some embodiments, printer 170 may also be capable of executing software including, a printer operating system, message processing and configuration software, and other appropriate application software. Exemplary printer 170 may allow files to be associated with one or more monitoring folders, file monitoring schemes, paper sizes, output trays, color selections, and print resolution, among other options, to be user-configurable.

Exemplary CPU 176 may be a general-purpose processor, a special purpose processor, or an embedded processor. CPU 176 can exchange data including control information and instructions with memory 172 and/or firmware 171. Memory 172 may be any type of Dynamic Random Access Memory (“DRAM”) such as but not limited to SDRAM, or RDRAM. Firmware 171 may hold instructions and data including but not limited to a boot-up sequence, pre-defined routines including routines to accelerate printing, configuration management, document processing, and other code. In some embodiments, code and data in firmware 171 may be copied to memory 172 prior to being acted upon by CPU 176. Data and instructions in firmware 171 may be upgradeable using one or more of computer 110, network 140, removable media coupled to printer 170, and/or secondary storage 173.

Exemplary CPU 176 may act upon instructions and data and provide control and data to ASICs/ FPGAs 178 and print engine 177 to generate printed documents. ASICs/FPGAs 178 may also provide control and data to print engine 177. FPGAs/ASICs 178 may also implement one or more of configuration management, folder monitoring, and other print related algorithms.

Intermediate and final printable data, messages, and configuration information pertaining to one or more printers 170 may be stored in memory 172 or secondary storage 173. Exemplary secondary storage 173 may be an internal or external hard disk, or a memory stick, USB drive, SDHC card, flash drive, or any other memory storage device capable of being used by system 200.

In some embodiments, a monitoring folder and files associated with the monitoring folder may be stored on secondary storage 173. One or more files accessible to printer 170 may be associated with the monitoring folder and pre-processed version of the files may be stored in the monitoring folder. Printer 170 may monitor attributes of the files associated with the monitoring folder depending on its configured monitoring scheme. In some embodiments, files associated with the monitoring folder may be pre-processed and stored in the monitoring folder to decrease printing time. For example, a file may be retrieved from network accessible storage, processed, and/or rasterized by printer 170 and stored in a monitoring folder. In some embodiments, the rasterized image may be stored on secondary storage 173. In some embodiments, the pre-processing may be done when printer 170 or CPU 176 is idle-during printer idle cycles.

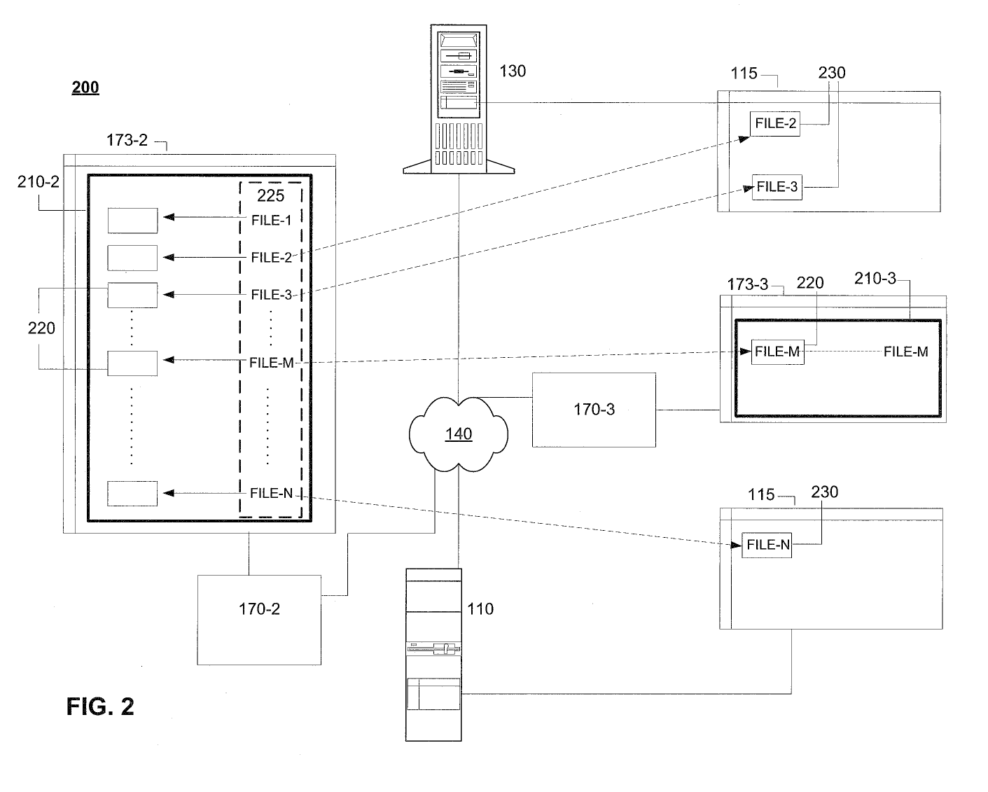

FIG. 2 shows exemplary system 200 for accelerated printing using monitoring folders consistent with disclosed embodiments. As shown in FIG. 2, monitoring folders 210-2 on printer 170-2 and 210-3 on printer 173 are associated with files 230 on server 130 and computer 110. In some embodiments, files 220 in monitoring folder 210-2 and 210-3 may be pre-processed versions of their respective associated files 230.

In some embodiments, monitoring folder 210-2 may be stored in secondary storage 173 coupled to printer 170. Note that although files 220 in monitoring folder 210-2 are shown as being stored in secondary storage 173, in some embodiments, one or more files 220, and/or a list of the monitored files 225 may be present in memory 172. In some embodiments, one or more files in monitoring folder 210-2 may also be present in memory 172 during pre-processing or printing.

In some embodiments, monitoring folders 210 may also include file list or file table 225 of files present in the monitoring folders 210. In some embodiments, file table 225 may comprise information that (i) identifies a file 230 associated with a file 220, (ii) provides information to locate the file 230, and (iii) holds attribute information associated with file 230 thereby associating the file attribute information for a file 230 with corresponding file 220. As shown in FIG. 2, files 220 listed in file table 225 may be associated with a file 230 using a soft link or “shortcut”. The dashed arrows in FIG. 2 indicate physical locations of files monitored by printer 170-2.

File table 225 may also include path or other information to locate a file 230 that is associated with a file 220 in monitoring folder 210. For example, file table 225 may indicate that monitored files “FILE-2” and “FILE-3” in folder 210-2 correspond to the files FILE-2 and FILE-3, respectively, resident on server 130, while monitored file “FILE-M” corresponds to FILE-M resident on printer 170-3, and monitored file “FILE-N” corresponds to FILE-N resident on computer 110.

As shown in FIG. 2, system 200 comprises two printers 170-2 and 170-3. Although, in general, system 200 may comprise of a number of networked printers in a variety of configurations, for ease of explanation, only two printers have been shown in FIG. 2. A system for accelerated printing described below for system 200 may be generalized and applied to any networked printer configuration as would be apparent to one of ordinary skill in the art.

As shown in FIG. 2, printer 170-2 may be configured to use a monitoring folder 210, which may include file table 225 containing information related to files 230 tracked by printer 170-2. For example, a user may utilize a graphical user interface to configure printer 170-2 by selecting network accessible files to populate file table 225. In some embodiments, file names for a pre-processed file 220 associated with a file 230 may be automatically generated and placed in the appropriate location in file table 225. After configuration, printer 170-2 may retrieve the selected files and file attributes, store file attribute information in file table 225, and store pre-processed versions 220 of the selected files in monitoring folder 210 in accordance with file name information in file table 225.

In some embodiments, printer 170-2 may monitor the files 230 associated with files 220 in monitoring folder 210-2 based on a user-configurable monitoring scheme. For example, printer 170-2 may be configured to monitor files 230 associated with files 220 in monitoring folder periodically, or whenever printer 170-2 is idle, or some combination thereof. Monitoring a file 230 associated with a file 220 may include checking for attribute changes associated with file 230 that could affect printed output generated using file 220. File attribute changes to a file 230 associated with file 220 can be used to indicate changes in document content. File attributes may include last editing time, last save time, file size, version or revision numbers, a file tracking number used by a document management system, and various other parameters that may directly or indirectly indicate changes to file content. In some embodiments, printer 170-2 may be configured to receive messages from a revision control system (“RCS”) or document management system so that the printer 170-2 is alerted to any changes in monitored files.

In some embodiments, printer 170-2 may retrieve files for pre-processing if there have been changes to one or more monitored file attributes since the file was last pre-processed. Pre-processed files 220 may be stored locally using secondary storage 173. In some embodiments, pre-processing may include one or more of retrieving the file, language processing, generating and storing an intermediate file format such as a display list representation of the document to be printed, and rasterization. Language processing may include actions related to the parsing of Page Description Languages (“PDLs”) such as Adobe PDF™, PostScript™, HP PCL™, Microsoft XPS™ etc.

In some embodiments, the files to be monitored by printer 170-2 may be obtained from another printer, such as printer 170-3. Accordingly, printer 170-2 may monitor and pre-process files (such as FILE-M) that may also be (or have previously been) monitored by printer 170-3. For example, if a mechanical malfunction, or a malfunction in a print subsystem is detected that prevents printer 170-3 from printing documents temporarily, then printer 170-2 may be configured to monitor and pre-process files that were monitored by printer 170-3. In some embodiments, the monitoring of files in monitoring folder 210-3 by printer 170-2 may be triggered by a message from printer 170-3 to 170-2. The message from printer 170-3 to printer 170-2 may include file/path-names, the monitoring scheme, and other information related to monitored file 230. In some embodiments, the monitoring of files for printer 210-3 by printer 210-2 may be terminated by another message from printer 210-3 to 210-2. For example, the monitoring of files in folder 210-3 may be terminated when printer 170-3 is capable of resuming normal operation. In some embodiments, one or more alternate monitoring printers may be specified during the configuration of printer 170-3.

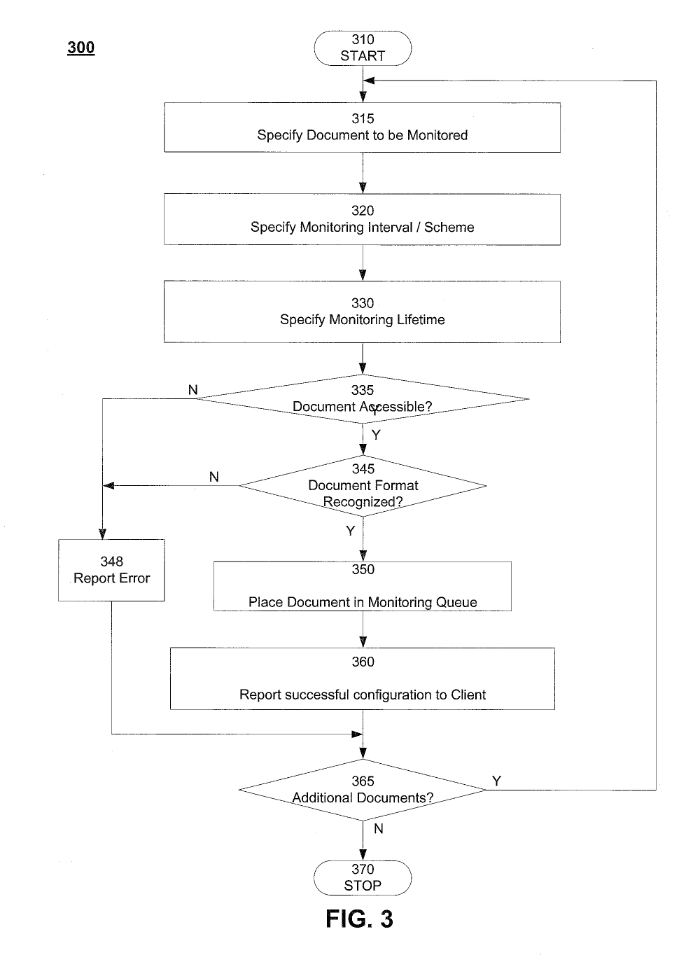

FIG. 3 shows a flowchart illustrating an exemplary method 300 for configuring printers to enable file monitoring. In some embodiments, method 300 may be executed using a graphical user interface (“GUI”) on consoles 190. In some embodiments, the GUI may be invoked by a driver for printers 170 running on computer 110 or server 130. In some embodiments, the GUI may be invoked by print controller 175 coupled to printer 170-1. Although specific file monitoring configuration options for printers are discussed below, various other configuration options may also be provided by method 300 as would be apparent to one of ordinary skill in the art.

Exemplary method 300 may commence with step 300. In step 315, a document 230 to be monitored may be specified. For example, the document 230 may reside on storage media (such as secondary storage 173 or 115) accessible over network 140 and may be selected by dragging and dropping an icon representing the file in a configuration GUI. In some embodiments, a user may be able to select or specify a monitoring folder specific to files specified by that user. In some embodiments, printer 170-2 may be configured to create a distinct monitoring folder for each user. In some embodiments, the files may be stored in a common monitoring folder 210 and users may be able to see a user-specific view of the monitoring folder that shows the files that the user has selected for monitoring.

In step 320, the user may specify a monitoring interval or another monitoring scheme. For example, the user may specify that a file is to be monitored every minute; or the user may specify that a file is to be monitored every minute during periods when printer 170-3 is idle. As a further example, the user may specify that a file is to be monitored whenever the average printer utilization rate over some time period is below some threshold. In general, the user may choose from a variety of monitoring schemes that are available and each file may be configured using a file-specific monitoring scheme. In some embodiments, printer 170-2 may place the files to be monitored in one or more monitoring scheme specific event queues after configuration. Files in an event queue may be processed and the event queue updated whenever the conditions specified in the monitoring scheme associated with the event queue are true. In some embodiments, a default monitoring scheme and event queue may be provided to permit quick configuration.

In step 330, the monitoring lifetime may be specified. For example, the user may specify a time period during which the file is to be monitored. In some embodiments, the user may indicate that monitoring for a file cease after it has been printed some specified number of times. In some embodiments, the user may indicate that monitoring for a file cease after the user has logged off.

Once a user has finished specifying configuration options the algorithm may check whether the files specified by the user are accessible, in step 335. If the specified file is not accessible (“N” in step 335), or the user does not have permission to access the specified file then the algorithm proceeds to step 348. If the document is accessible (“Y” in step 335), then, in step 345, the algorithm may check whether the file format is one recognized by printer 170-2. If the format of the specified file is not recognized by the printer (“N” in step 345), then the algorithm proceeds to step 348. In step 348, an error may be reported to the user and the algorithm may proceed to step 365. If the format of the specified file is recognized by the printer (“Y” in step 345), then, in step 350, the document can be placed in an appropriate event monitoring queue and the algorithm proceeds to step 360.

In step 360, the algorithm may report that the file was successfully added to the monitoring queue. If there are no additional files to be configured the algorithm may terminate in step 370. If there are additional files that the user wishes to configure, then the algorithm returns to step 315 to start another iteration.

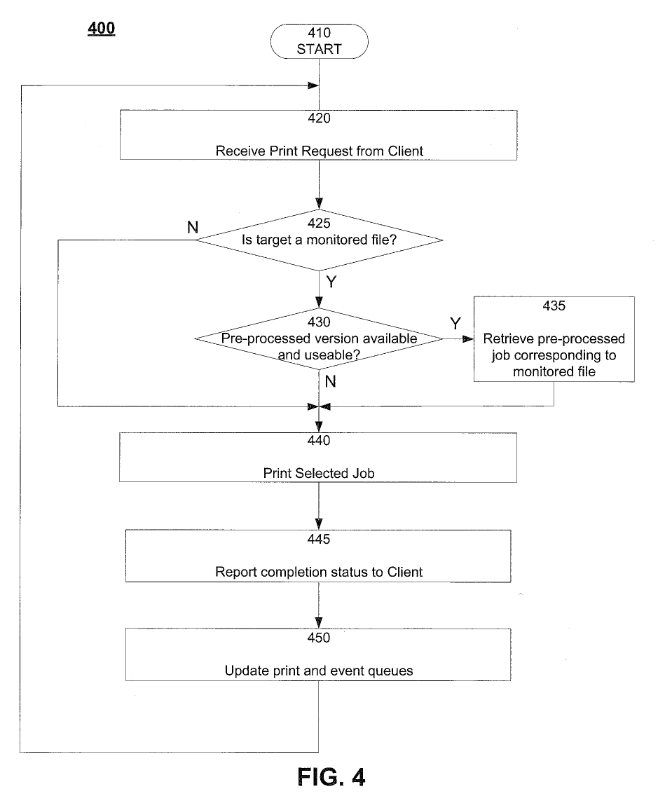

FIG. 4 shows a flowchart depicting an exemplary method 400 for the fast printing of files according to disclosed embodiments. In some embodiments, method 400 may be performed by printer 170-2. In another embodiment, method 400 may be performed by print controller 175 and printer 170-1. Exemplary method 400 may commence with step 410. In step 420, a print request for a document such as a file 230 may be received.

In step 425, the algorithm may determine whether the target of the print request is a monitored file 230. For example, if the print request is for FILE-2 on server 130, then printer 170-2 may check file table 225 and determine that FILE-2 is a monitored file 230 that corresponds to “FILE-2” 220 in monitoring folder 210-2. If the print request is for a monitored file (“Y” in step 425) then, in step 430, the monitoring folder 210-2 is checked to see if a pre-processed version 220 of the file “FILE-2” is available and useable. A pre-processed file 220 may be categorized as useable if the file 230 associated with file 220 has not changed since the file 230 was last pre-processed. If the monitoring folder includes a useable pre-processed version 220 of the target 230 of the print request (“Y” in step 430) then, in step 435, the pre-processed version 220 may be loaded into memory 172 from secondary storage 173 (if it is not already present in memory 172). In step 440, the pre-processed file 220 may be processed additionally depending on the extent of prior pre-processing carried out and then printed by printer 170-2.

If the target is not a monitored file (“Y” in step 425), or a pre-processed version is not available and useable (“N” in step 430) then, the algorithm proceeds to step 440, where the file 230 may be retrieved from its storage location, received over the network, processed, and then printed.

In step 445, the completion status of print job may be reported to the user. For example, the user may receive an indication if the print job was successfully printed or an error message otherwise. In step 450, the print queue may be updated depending on the completion status of the print job. For example, the print job may be removed from the print queue if it completed successfully. In some embodiments, event queue may also be updated depending on the user-specified monitoring lifetime for the file 230. The algorithm may then return to step 420, to commence a new iteration and process the next print request.

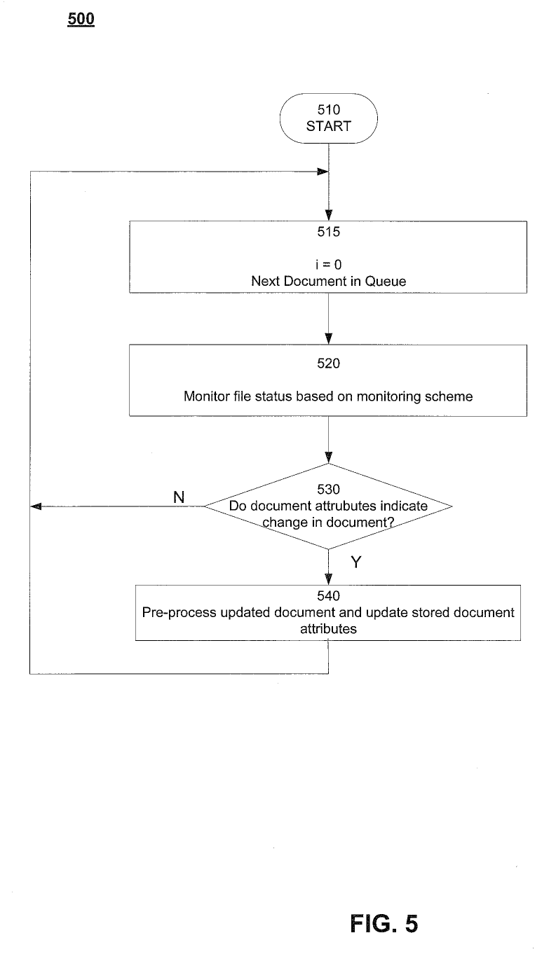

FIG. 5 shows an exemplary flowchart for a file monitoring method 500 consistent with disclosed embodiments. In some embodiments, portions of method 500 may be performed by one or more of printers 170 and/or print controller 175. In some embodiments, method 500 may be performed by a printer 170 whenever the printer 170 is idle. In some embodiments, a print controller 175 coupled to printer 170-5 may be capable of performing method 500 even when coupled printer 170 is busy printing documents. Exemplary method 500 may commence with step 510. In step 515, the first or next file in an event monitoring queue may be selected. In step 520, the current status of the selected file 230 may be obtained. For example, printer 170-2 may obtain one or more file attributes for FILE-2 on server 130.

In step 530, the obtained file attributes may be compared with stored file attribute information in file table 225. For example, the current file size or last save time of FILE-2 on server 130 may be compared with stored file attribute information for the file in file table 225. If the comparison indicates that file attributes for file 230 have changed (“Y” in step 530), then, in step 540, file 230 may be retrieved and pre-processed to generate a new pre-processed version 220. In addition, stored file attributes pertaining to file 230 may be updated in file table 225 to reflect current file attribute information. If file attribute information for file 230 indicates that file content has not changed, then the algorithm returns to step 515, where it proceeds to the next document in the event queue. In embodiments where multiple event monitoring queues are used the queues may be processed in turn, or according to some pre-determined priority.

In some embodiments, a program for conducting the process described in algorithm 400 can be recorded on computer-readable media 150 or computer-readable memory. These include, but are not limited to, Read Only Memory (ROM), Programmable Read Only Memory (PROM), Flash Memory, Non-Volatile Random Access Memory (NVRAM), or digital memory cards such as secure digital (SD) memory cards, Compact Flash™, Smart Media™, Memory Stick™, and the like. In some embodiments, one or more types of computer-readable media may be coupled to printer 170. In certain embodiments, portions of a program to implement the systems, methods, and structures disclosed may be delivered over network 140.

Other embodiments of the present invention will be apparent to those skilled in the art from consideration of the specification and practice of one or more embodiments of the invention disclosed herein. It is intended that the specification and examples be considered as exemplary only, with a true scope and spirit of the invention being indicated by the following claims.

What is claimed is:

1. A processor implemented method for printing at least one first file associated with stored attribute information pertaining to a second file, wherein the first file is obtained by pre-processing the second file, the method comprising the processor implemented steps of:
receiving a print request for the second file;
retrieving current file attribute information pertaining to the second file;
determining if there are content changes to the second file by comparing the retrieved file attribute information with the stored file attribute information; and
printing the first file, if there are no content changes to the second file.

2. The processor implemented method of claim 1, further comprising printing the second file, if there are content changes to the second file.

3. The processor implemented method of claim 1, wherein the method is performed on a first printer.

4. The processor implemented method of claim 3, wherein the pre-processing of the second file to obtain the first file is performed when the first printer is idle.

5. The processor implemented method of claim 3, wherein the first file is stored on secondary storage coupled to the first printer.

6. The processor implemented method of claim 3, wherein the first printer may configure a second printer to perform the method, if a malfunction in a print subsystem of the first printer is detected.

7. The processor implemented method of claim 1, wherein the second file is accessed over a network.

8. The processor implemented method of claim 1, wherein the method is performed on a print controller coupled to a printer.

9. The processor implemented method of claim 1, wherein the file attribute information for the second file comprises at least one of:
file size;
last file update time;
last file edit time; or
last file save time.

10. The processor implemented method of claim 1, wherein pre-processing the second file comprises at least one of:
applying language processing to the second file;
obtaining a display list representation of the second file; or
rasterizing the second file.

11. A computer-readable medium that stores instructions, which when executed by a processor performs steps in a method for printing at least one first file associated with stored attribute information pertaining to a second file, wherein the first file is obtained by pre-processing the second file, the method comprising the processor implemented steps of:
receiving a print request for the second file;
retrieving current file attribute information pertaining to the second file;
determining if there are content changes to the second file by comparing the retrieved file attribute information with the stored file attribute information; and
printing the first file, if there are no content changes to the second file.

12. The computer-readable medium of claim 11, further comprising printing the second file, if there are content changes to the second file.

13. The computer-readable medium of claim 11, wherein the method is performed on a first printer.

14. The computer-readable medium of claim 13, wherein the pre-processing of the second file to obtain the first file is performed when the first printer is idle.

15. The computer-readable medium of claim 13, wherein the first file is stored on secondary storage coupled to the first printer.

16. The computer-readable medium of claim 13, wherein the first printer may configure a second printer to perform the method, if a malfunction in a print subsystem of the first printer is detected.

17. The computer-readable medium of claim 11, wherein the second file is accessed over a network.

18. The computer-readable medium of claim 11, wherein the method is performed on a print controller coupled to a printer.

19. The computer-readable medium of claim 11, wherein the file attribute information for the second file comprises at least one of:
file size;
last file update time;
last file edit time; or
last file save time.

20. The computer-readable medium of claim 11, wherein pre-processing the second file comprises at least one of:
applying language processing to the second file;
obtaining a display list representation of the second file; or
rasterizing the second file.
